(19) United States
(12) Patent Application Publication
(10) Pub. No.: US 2008/0281958 A1
(43) Pub. Date: Nov. 13, 2008

(54) Unified Console For System and Workload Management

(75) Inventors: Casey McKinnon, Seattle, WA (US); Thomas W. Keane, Seattle, WA (US); Thomas N. Martino, Bellevue, WA (US); Syed Nadir Ahmed, Redmond, WA (US); John William Podlogar, JR., Allison Park, PA (US); Roger W. Sprague, Seattle, WA (US); Appireddy Kikkuru, Redmond, WA (US); Aaron Gaskill, Kirkland, WA (US); Anandha K. Ganesan, Redmond, WA (US); Jeff Podlogar, Allison Park, PA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/746,369

(22) Filed: May 9, 2007

(51) Int. Cl. G06F 15/173

(52) U.S. Cl. 709/224

(57) ABSTRACT

Disclosed are systems and methods for implementing a unified console for managing computing-based devices. Described is a unified management solution to efficiently manage one or more workloads or a plurality of tasks performed by a user for managing the resources of applications in a computer network that includes the computing-based devices. The system can be implemented by providing a combined functionality that includes features of monitoring and update services, in a single console.

### BACKGROUND

Generally, in a client-server network architecture client devices are monitored by a server, and the server is responsible for managing workloads. Workloads can be considered as tasks that are to be performed by an individual or user, such as a system administrator. Examples of commonly known workloads include software updates or updations, software installations, software patch deployment, etc.

Existing systems for managing client devices may include maintaining separate workloads and separate configurations for each client device, and individually configure each workload using different applications or services. For example, in certain existing operating systems, particular services may accomplish tasks such as monitoring, diagnostics, and troubleshooting. In addition to these tasks, other services (e.g., update services) may deal with tasks such as patching, software distribution, and inventory collection. In such implementations, workload is individually and separately configured, making simultaneous configuration of workloads virtually unattainable.

In addition, for example, many workloads use group policy functionality to ensure proper policies are applied for each workload per computer group. Currently these policies may have to be created separately for each workload using different applications, requiring users to denote administrators for each one of the workload used by the users.

### SUMMARY

This summary is provided to introduce concepts for implementing a unified console for system and workload management. These concepts are further described below in the detailed description. This summary is not intended to identify essential features of the claimed subject matter, nor is it intended for use in determining the scope of the claimed subject matter.

A method for implementing workload management is described. In an embodiment, the method includes detecting computing devices in a network, detecting the computing devices and groups of groups of computing devices in which a workload is to be implemented, configuring the workload across the computing devices and groups of computing devices, and applying the configured workload over the computing devices and groups of computing device in which the workload is to be implemented.

### BRIEF DESCRIPTION OF THE DRAWINGS

FIG. 1 illustrates an exemplary network architecture for implementing a system management.

FIG. 2 illustrates an exemplary server computing device.

FIG. 3 illustrates an exemplary user interface for implementing system and workload management.

FIG. 4 illustrates an exemplary user interface that depicts monitoring status of one or more systems.

FIG. 5 illustrates an exemplary report provided to a user.

FIG. 6 illustrates an exemplary process flow for performing workload management.

FIG. 7 illustrates exemplary method(s) for implementing system management in a network.

### DETAILED DESCRIPTION

Systems and methods for implementing a unified console for managing one or more computing-based devices are described. Such systems and methods provide a unified management solution to efficiently manage one or more workloads. Workloads are a plurality of tasks that are performed by an individual (e.g., a system administrator) for managing the resources or applications in a computer network. Examples of such workloads include, but are not limited to, implementing security, updating or updation of system related files and other files, performance monitoring, troubleshooting, etc. Such a system can be implemented by providing a combined functionality that includes features of monitoring and update services, in a single console. Some of the services that perform similar, but independent functions include Microsoft® System Center Operations Manager and Windows Server Update Services (WSUS).

System for resource management can include computing devices in a network. The devices can further be segregated into various computer groups or groups to facilitate cross-workload management. In such cases, workload configuration can be performed, which allows a system administrator to configure one or more settings across different groups.

Configuration of workload configuration can be dictated by a group policy, which ensures that proper and uniform policies are implemented for all workloads of associated machines forming a part of a group. Similarly, multiple workload configurations can be implemented across multiple computing devices or groups of computers using a single console.

In an implementation, such systems also allow users to view specific information in individual as well as aggregate form. Such information may be indicative of the state of the system to which the information pertains. The information can then be presented to the user, as further discussed below.

While aspects of the described systems and methods for implementing a unified console for managing servers, clients, hardware, software, and IT services can be implemented in any number of different computing systems, environments, and/or configurations, the embodiments are described in the context of the following exemplary system architecture(s).

### An Exemplary System

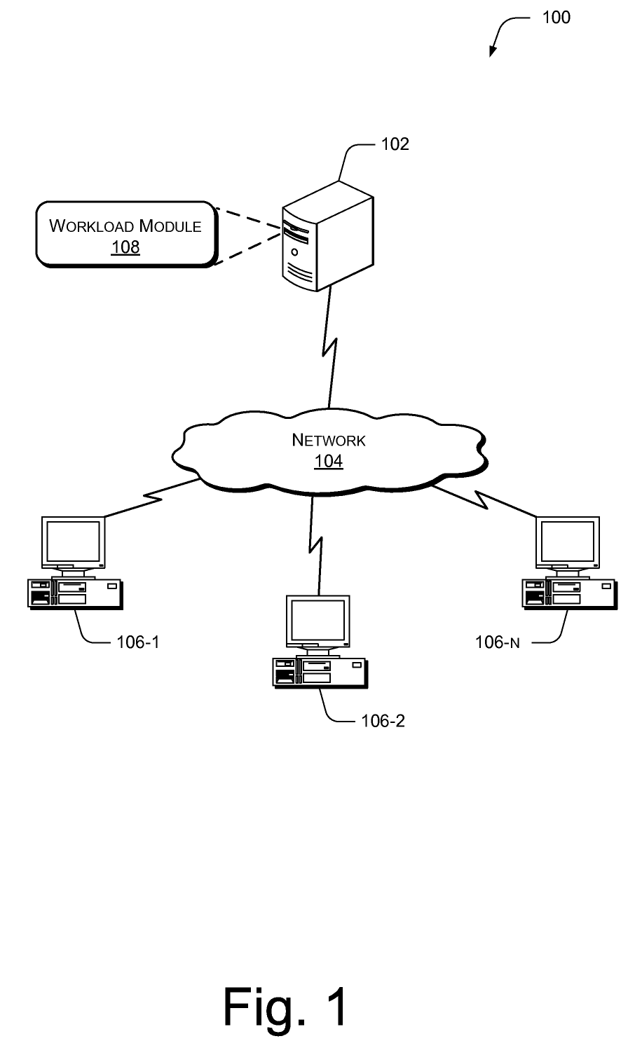

FIG. 1 shows an exemplary system 100 for a computer network based on client-server architecture. System 100 includes server computing device 102 communicating with one or more client computing devices 106(1)-(N) through a network 104. For example, system 100 can be a company network, including a number of office PCs, various servers, or other computing devices spread over several countries. Alternately, system 100 can include a home network with a limited number of PCs belonging to a single family.

Server computing device 102 can be implemented in many ways including, for example, as a standalone general purpose computing device or a mainframe, or as a cluster of servers (e.g., arranged in a server farm). Client computing devices 106(1)-(N) or client computing devices 106 can be implemented in any number of ways including, for example, as general purpose computing devices, laptops, etc.

Client computing devices 106 can be coupled to each other or to server computing device 102 in various combinations through network 104. Network 104 may be a wireless or a wired network, or a combination thereof. Network 104 may also be a collection of individual networks, interconnected with each other and functioning as a single large network (e.g., the Internet or an intranet). Examples of such individual networks include, but are not limited to, Local Area Networks (LANs), Wide Area Networks (WANs), and Metropolitan Area Networks (MANs). Network 104 may also include network devices such as hubs, switches, routers, and so on.

System 100 can be implemented with server computing device 102 running an operating system that allows one or more client computing devices 106 to access applications installed or hosted on the server computing device 102.

In one implementation, server computing device 102 manages one or more resources implemented in client computing devices 106, for example, one or more applications that may be installed on computing devices 106. Server computing device 102 can include one or more agents or modules such as workload module 108. Such modules can manage workloads such as status monitoring, performance monitoring, data updation, software distribution, patch deployment and so on in one or more of client computing devices 106. Server computing device 102 additionally includes machine executable instructions for implementing a console or a user interface. Agents or modules in server computing device 102, or workload module 108, interact with one or more components in client computing devices 106 to collect data associated with the state of system and/or manage updation schedules for them. The functionality of workload module 108 can be controlled through the console or user interfaces.

As discussed above, workload module 108 can perform tasks related to management of one or more workload tasks associated with one or more of client computing devices 106. Examples of such tasks include monitoring, diagnostics, event tracking, etc. Workload module 108 also can allow a user (e.g. a system administrator) to update one or more components on server computing device 102 or client computing devices 106; provide for policy implementation; and other tasks. Workload module 108 may also enable a user or system administrator, to generate and view information in relation to one or more of client computing devices 106. Such information can be associated with the state of system under consideration. A state of system can be understood to include the general attributes that are defined for a system. For example, the state of system can include information in relation to the applications that are installed on the system. Additionally, other attributes may also be responsible for defining the state of the system, such as group membership, role in an organization, etc.

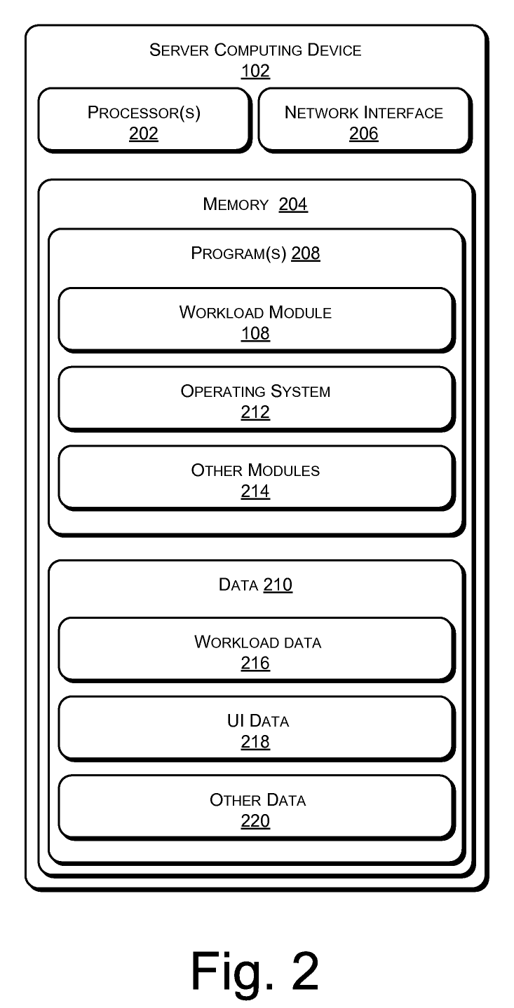

It is to be appreciated that one or more of client computing devices 106 can be associated with a group that are characterized by common attributes. For example, a reference to one or more client computing devices 106 can also include computing devices 106 that are associated with a group, and/or governed by one or more common attributes. Workload module 108 is described in greater detail in conjunction with FIG. 2.

### An Exemplary Server Computing Device

FIG. 2 shows an exemplary server computing device 102 for implementing system workload management in a computing system, for example, in server computing device 102 or one or more of client computing devices 106. In addition to workload management, server computing device 102 can also include agents or modules for monitoring a system. Server computing device 102 can include one or more processors 202, a memory 204 and a network interface 206.

Memory 204 can include any computer-readable medium known in the art including, for example, volatile memory (e.g., RAM) and/or non-volatile memory (e.g., flash, etc.). Memory 204 can include one or more program(s) 208 and data 210. Program(s) 208 can include workload module 108, operating system 212, and other modules 214. Other modules 214 include one or more modules that may supplement the working of workload module 108, operating system 212, and so on. Data 210 includes any information that may be required or generated by one or more program(s) 208, such as workload data 216, UI data 218, and other data 220.

Processor(s) 202 can include microprocessors, microcomputers, microcontrollers, multi-core processors, etc. Processor(s) 202 are configured to fetch and execute computer-program instructions stored in memory 204. Memory 204 stores computer executable instructions, program(s) 208, and data 210 for identifying events occurring in the system 100 and for collecting configuration details of the managed system 100.

Network interface 206 includes a mechanism for providing an interface for allowing communication between server computing device 102 and one or more client computing devices 106. Network interface 206 can implemented through be a network interface card installed on the server computing device 102.

As discussed above, workload module 108 implements workload management in server computing device 102. Workload module 108 can also affect similar tasks in one or more of client computing devices 106 like component updation, implementing policy, generating reports, etc. Data essential for affecting such actions is stored in workload data 216. Examples of information stored in workload data 216 include information associated with updation like patch information, system information, reports generated, and so on. In addition, workload module 108 may be instrumented to allow information retrieval associated with various workloads. Workload module 108 displays such information to an individual through a user interface. In an implementation, the user interface can be generated by workload module 108. The user interface can also be used for managing workloads for server computing device 102, and/or one or more client computing devices 106.

Workload module 108 generates the user interface based on UI data 218. Data generated by workload module 108 may then be displayed in conformance with the user interface created using UI data 218. Therefore, system and workload management can be implemented through a single unified console. The manner in which workload module 108 provides one or more services is further described in detail below.

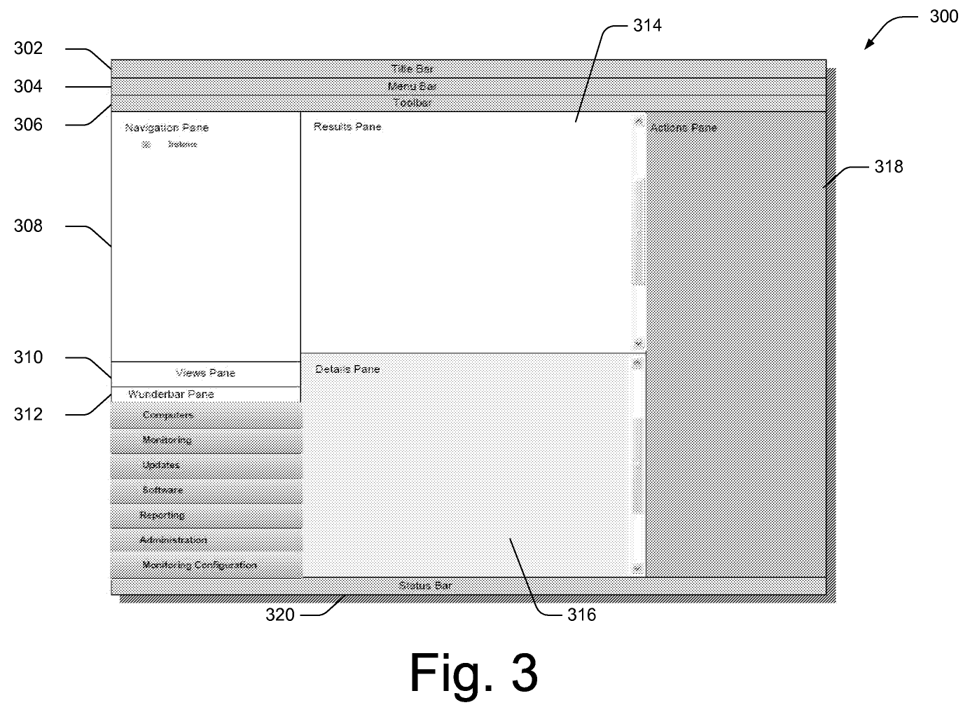

FIG. 3 illustrates an exemplary implementation of a user interface 300 implementing a system and workload management. User interface 300 includes one or more distinct areas or portions. It is be appreciated that user interface 300 is made available on execution of instructions for implementing workload and system management.

User interface 300 and workload module 108 together provide a single console for managing server computing device 102, and client computing devices 106. In addition to the individual devices, client computing devices 106 can be grouped together into one or more groups, allowing workload management to function across multiple client computing devices 106 at one go.

System management and associated workload functions are performed through user interface 300 and provide convenient means for navigating through various options of the management system.

As discussed above, the user interface 300 is implemented through computer executable instructions. Upon execution of these instructions user interface 300 connects to each workload component. An individual (e.g., a system administrator) can specify through user interface 300 one or more client computing devices 106 on which workloads are to be performed. During the performing of these workloads, user interface 300 manages and maintains the connection between itself and the respective workloads, allowing active communication between the system administrator and the system on which the workloads are being implemented.

In an implementation, system and workload management can be affected in an organized manner by implementing the workloads across groups of computing-based devices. Workload module 108 allows creation of computer groups based on one or more attributes. These attributes can be specified by the system administrator or can be chosen from a collection of pre-specified criteria that would dictate the formation of a group. In a particular implementation, workload module 108 creates groups of client computing devices 106 dynamically, such as based on fulfillment of certain conditions or depending on the type of workloads that are to be performed across one or more client computing devices 106.

Workload module 108 distributes one or more workloads across the groups to facilitate cross-workload management. This allows one or more workloads to be performed for all computing based devices included within a given group. For example, through user interface 300, a system administrator can select one or more groups over which a workload (e.g., monitoring) is to be applied. Workload module 108 then implements the specific workload onto the selected groups. Furthermore, workloads can be applied using group policy functionalities, ensuring that policy implementation across one or more of client computing devices 106 is uniformly achieved. For example, group policies can be implemented on one or more groups by associating the policies to be applied with the associated group.

Access to configure and manage group policies and related workloads can be controlled with the use of access control lists (ACL). Generally an ACL can be described to include a list of permissions attached to an object. The list specifies entities that can access the object and specifies operations that are allowed to be performed on the object. For example, associating a user (e.g., user X), with an operation such as “delete”, would imply delete rights are associated with user X. All group policies can be created and maintained during initial configuration of the management system by workload module 108. These policies can then be included in the ACL associated with groups including one or more client computing devices 106.

User interface 300 can be implemented through various computer executable instructions that are known in the art. User interface 300 includes one or more display elements that provide additional functionality to user interface 300, in addition to making the system and workload management system more amenable to a user.

Display elements such as title bar 302, menu bar 304, toolbar 306 are portions that are similar to display elements that are commonly provided with software applications. In addition to these display elements, user interface 300 also includes navigation pane 308, views pane 310, “wunderbar” pane 312, result pane 314, detail pane 316 and action pane 318.

Navigation pane 308 allows access to specific instances of the service that a user wishes to access. For example, navigation pane 308 allows navigating directly to a memory location such as a folder, containing one or more services a user wishes to access. Views pane 310 include options for adding new devices (e.g., one or more of client computing devices 106), or creating a new group, etc.

Wunderbar pane 312 contains control elements that can be used for performing functions associated with system and workload management. Wunderbar pane 312 can also include access elements, such as tabs, that allow a user to view properties and attributes associated with the tab. For example, a tab for computing devices, when selected or clicked, would display one or more attributes that are associated with all computing devices (e.g., client computing devices 106). Examples of such attributes include groups that a computing device may be a part of, applications that are installed, etc. The generated result can be displayed in result pane 314. In an implementation, additional details associated with choices present in wunderbar pane 312 can be displayed in detail pane 316.

Context specific actions, pertaining to a workload, are displayed in action pane 318. In an implementation, action pane 318 is split up into several discrete groupings of actions such as software actions, reports, help etc. Each action grouping can be opened or closed as a selectable drop down menu. Status bar 320 displays information about the current state of its window. For example, it may show information about total number of items listed in result pane 314 and the number of items that are currently selected or highlighted.

One or more exemplary operations that are performed as a part of system and workload management are discussed in the following portions.

### Monitoring Operations

Workload module 108 provides central monitoring and automatic problem resolution for server computing device 102 or one or more client computing devices 106. Workload module 108 continuously monitors user actions, application software on server computing device 102 and client computing devices 106. Operations manager 108 manages system 100 by handling workloads such as monitoring, diagnostics, troubleshooting, and so on. Workload module 108 continuously monitors one or more client computing devices 106 or server computing device 102 for errors or malfunctions in their working. An anomaly detected by workload module 108 may be notified to a user or a system administrator.

Workload module 108 then takes proactive measures for diagnosing and correcting the problem. In addition workload module 108 also tracks health status of a system, information associated with its performance, event information, and so on.

In one implementation, workload module 108 provides with inventory details of components that are functioning in association with a specific machine. Software and hardware inventory information allows a system administrator to review assets for optimum configuration and compliance with system 100. Workload module 108 allows searching and filtering the inventory information to generate updated lists of all installed software applications and hardware inventory.

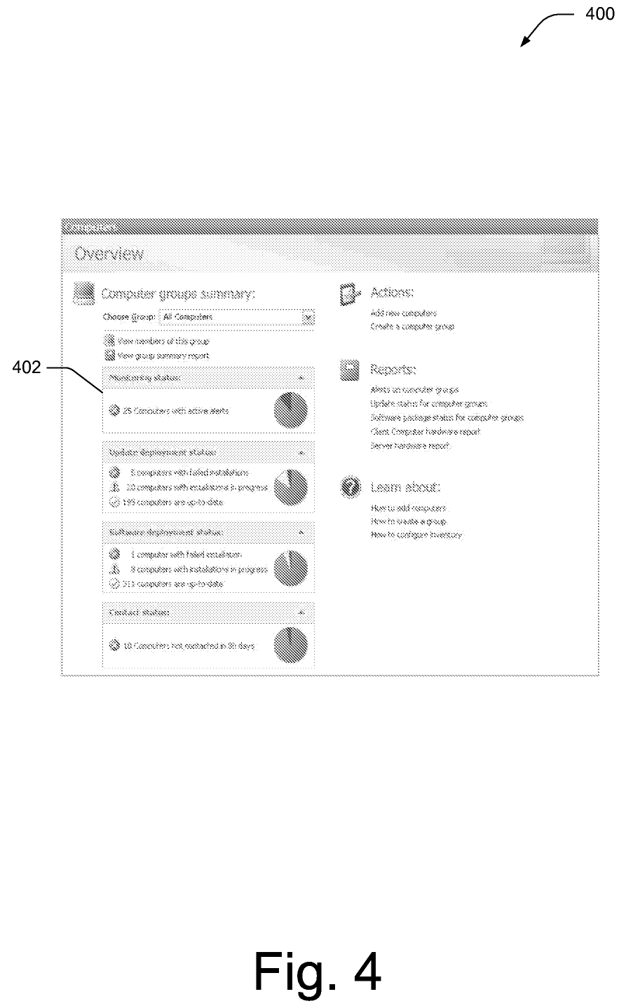

FIG. 4 illustrates an exemplary interface 400 that depicts the monitoring status of one or more systems, for example, client computing devices 106. Interface 400 indicates various states of client computing devices 106. For example, field 402 indicates the monitoring status of one or more of client computing devices 106. Interface 400 can also include other illustrating fields such as fields depicting deployment status of applications that are installed. Furthermore, visual features can additionally be used for briefly summarizing the displayed information. It is to be appreciated by a person skilled in the art, that other features can be added to interface 400, for displaying additional information. In other words, interface 400 is not to be considered as a limitation to monitoring performed by workload module 108.

### Updation Operations

As discussed above, workload includes updating or updation that may be performed on computing based devices (e.g., client computing devices 106). In an implementation, an update module in other modules 214 provides software update services for applications that may be installed on one or more of client computing devices 106 or server computing device 102. The services or agents that provide for updation can be centrally managed by a system administrator who can then manage distribution of updates to client computing devices 106.

In an implementation, workloads such as patching, software distribution, inventory collection, etc. can also be handled by the update module. In such cases workload module 108 allows system administrator to define an update schedule for server computing device 102 or client computing devices 106. In this manner, a schedule is prepared which defines update parameters such as applications to patch, types of updates to download, etc. Further updates can be checked for and a notification can be provided allowing a system administrator to make appropriate and timely update decisions. Furthermore, updation and related services can be implemented by workload module 108.

### Reporting Operations

A reporting module in other modules 214 allows for generating workload information as reports. Workload information generated as reports should be easy to review and allow a system administrator to review system state and status of components that are installed on the system. In an implementation, reports generated include all information associated processes such as asset inventory, software deployment, update compliance, etc.

The reporting module allows aggregation of one or more workload related information across all of the client computing devices 106 or of groups that include client computing devices 106. In one implementation, reporting and report generation is performed by workload module 108.

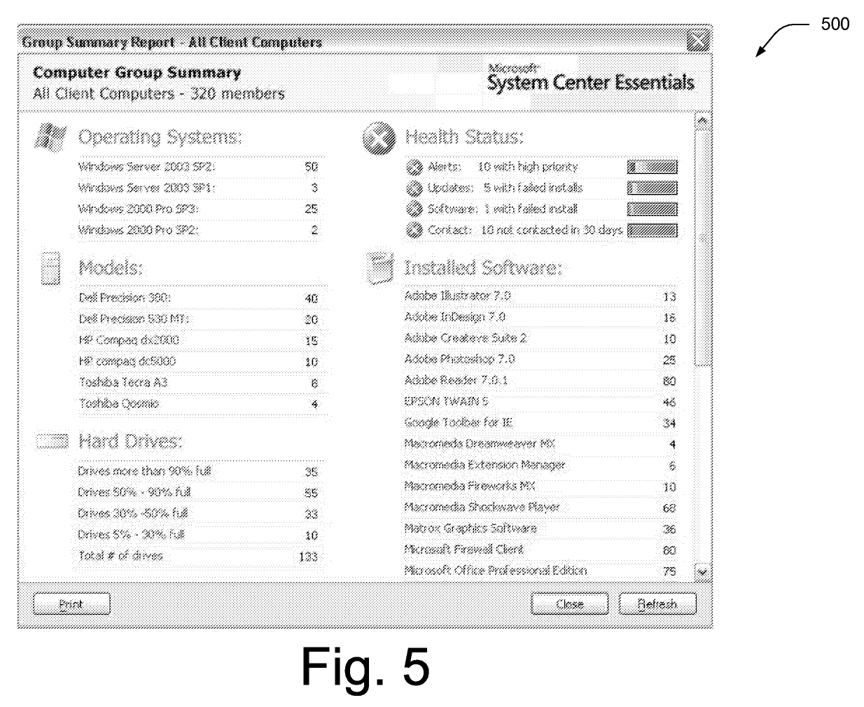

In another implementation, workload module 108 can provide system information associated with server computing device 102 or client computing devices 106. Examples of system information include details about operating systems installed on client computing devices 106, processors employed, installed software, health status, and so on. Workload module 108 allows for the physical reproduction of the generated reports. In another implementation, workload module 108 stores the generated information in other data 220. FIG. 5 illustrates an exemplary report 500 highlighting types of operating system installed, model name, hardware characteristics, health status, installed software, and so on. Report 500 is an example and illustrative, and should not be considered to be limiting in any respect.

### Exemplary Method(s)

Exemplary methods for implementing system and workload management are described with reference to FIGS. 1 to 5. These exemplary methods may be described in the general context of computer executable instructions. Generally, computer executable instructions can include routines, programs, objects, components, data structures, procedures, modules, functions, and the like that perform particular functions or implement particular abstract data types. The methods may also be practiced in a distributed computing environment where functions are performed by remote processing devices that are linked through a communications network. In a distributed computing environment, computer executable instructions may be located in both local and remote computer storage media, including memory storage devices.

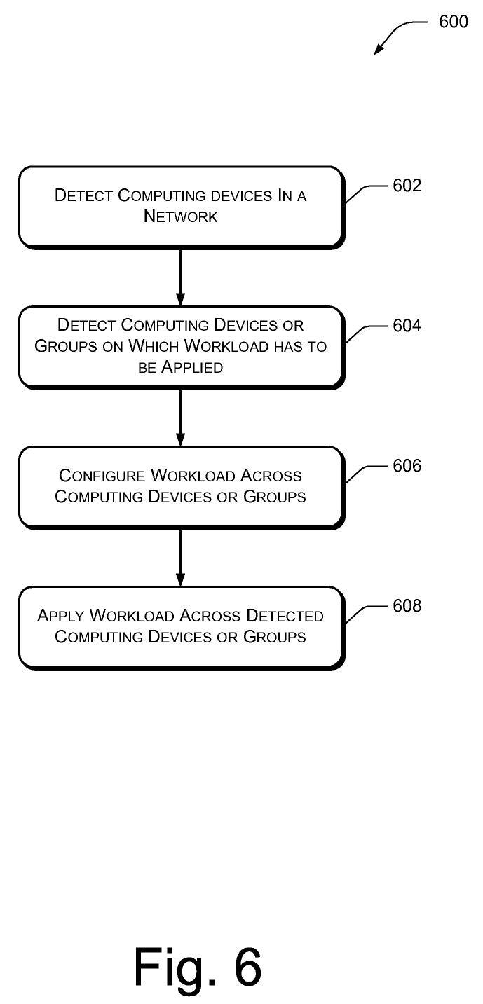

FIG. 6 illustrates an exemplary method 600 being implemented for performing workload management on a computing-based device, for example, server computing device 102 or one or more of client computing devices 106.

The order in which the method is described is not intended to be construed as a limitation, and any number of the described method blocks can be combined in any order to implement the method, or an alternate method. Additionally, individual blocks may be deleted from the method without departing from the spirit and scope of the subject matter described herein. Furthermore, the method can be implemented in any suitable hardware, software, firmware, or combination thereof.

At block 602, machines in a network are detected. For example, workload module 108 in server computing device 102 when executed, scans across the entire network and detects one or more client computing devices 106 that may be connected to the network. The network can be a wired or wireless network.

At block 604, computing devices or groups over which a workload is to be implemented, are detected. In an implementation, workload module 108 detects one or more client computing devices 106 or groups in which a workload, such as monitoring, is to be performed. Client computing devices 106 can be individual machines or can exist as groups. Groups are created on the basis of characteristics that are common to one or more client computing devices 106. For example, a group may be dictated by a group policy that aggregates one or more client computing devices 106 into a group.

At block 606, one or more workload is configured across all computing devices or groups including one or more computing devices. For example, workload module 108 configures the workloads across all client computing devices 106 or groups that include one or more of client computing devices 106. In an implementation, a user (e.g., a system administrator) can configure workloads for one or more of client computing devices 106 or groups through a user interface, such as user interface 300. In another implementation, a workload like policy implementation can be defined as a group policy. On configuring, the list is maintained as an Access Control List (or an ACL) with the respective computing device.

At block 608, the configured workload is applied onto the respective computing devices. For example, workload module 108, on configuring the respective workload, such as on the basis of group policy, applies the workload onto the detected client computing devices 106.

### Exemplary Computer Environment

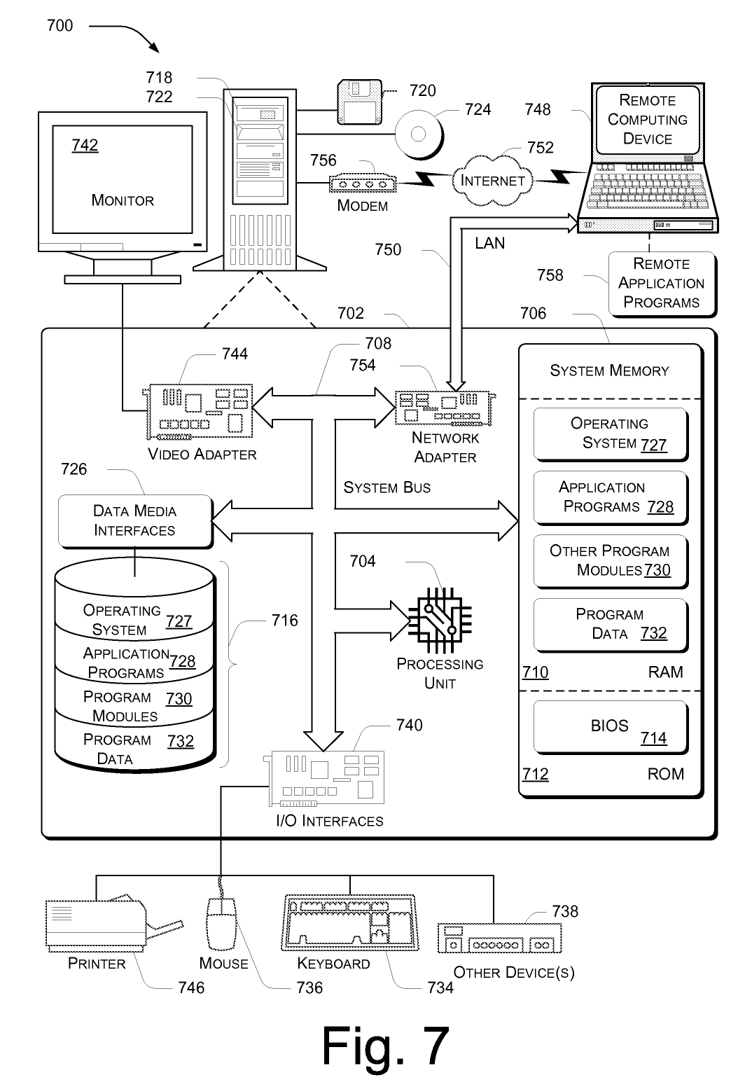

FIG. 7 illustrates an exemplary general computer environment 700, which can be used to implement the techniques described herein, and which may be representative, in whole or in part, of elements described herein. The computer environment 700 is only one example of a computing environment and is not intended to suggest any limitation as to the scope of use or functionality of the computer and network architectures. Neither should the computer environment 700 be interpreted as having any dependency or requirement relating to any one or combination of components illustrated in the example computer environment 700.

Computer environment 700 includes a general-purpose computing-based device in the form of a computer 702. Computer 702 can be, for example, a desktop computer, a handheld computer, a notebook or laptop computer, a server computer, etc. The components of computer 702 can include, but are not limited to, one or more processors or processing units 704, a system memory 706, and a system bus 708 that couples various system components including the processor 704 to the system memory 706.

The system bus 708 represents one or more of any of several types of bus structures, including a memory bus or memory controller, a peripheral bus, an accelerated graphics port, and a processor or local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

Computer 702 typically includes a variety of computer readable media. Such media can be any available media that is accessible by computer 702 and includes both volatile and non-volatile media, removable and non-removable media.

The system memory 706 includes computer readable media in the form of volatile memory, such as random access memory (RAM) 710, and/or non-volatile memory, such as read only memory (ROM) 712. A basic input/output system (BIOS) 714, containing the basic routines that help to transfer information between elements within computer 702, such as during start-up, is stored in ROM 712. RAM 710 typically contains data and/or program modules that are immediately accessible to and/or presently operated on by the processing unit 704.

Computer 702 may also include other removable/non-removable, volatile/non-volatile computer storage media. By way of example, FIG. 7 illustrates a hard disk drive 716 for reading from and writing to a non-removable, non-volatile magnetic media (not shown), a magnetic disk drive 718 for reading from and writing to a removable, non-volatile magnetic disk 720 (e.g., a “floppy disk”), and an optical disk drive 722 for reading from and/or writing to a removable, non-volatile optical disk 724 such as a CD-ROM, DVD-ROM, or other optical media. The hard disk drive 716, magnetic disk drive 718, and optical disk drive 722 are each connected to the system bus 708 by one or more data media interfaces 726. Alternately, the hard disk drive 716, magnetic disk drive 718, and optical disk drive 722 can be connected to the system bus 708 by one or more interfaces (not shown).

The disk drives and their associated computer-readable media provide non-volatile storage of computer readable instructions, data structures, program modules, and other data for computer 702. Although the example illustrates a hard disk 716, a removable magnetic disk 720, and a removable optical disk 724, it is to be appreciated that other types of computer readable media which can store data that is accessible by a computer, such as magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like, can also be utilized to implement the exemplary computing system and environment.

Any number of program modules can be stored on the hard disk 716, magnetic disk 720, optical disk 724, ROM 712, and/or RAM 710, including by way of example, an operating system 727, one or more application programs 728, other program modules 730, and program data 732. Each of such operating system 727, one or more application programs 728, other program modules 730, and program data 732 (or some combination thereof) may implement all or part of the resident components that support the distributed file system.

A user can enter commands and information into computer 702 via input devices such as a keyboard 734 and a pointing device 736 (e.g., a “mouse”). Other input devices 738 (not shown specifically) may include a microphone, joystick, game pad, satellite dish, serial port, scanner, and/or the like. These and other input devices are connected to the processing unit 704 via input/output interfaces 740 that are coupled to the system bus 708, but may be connected by other interface and bus structures, such as a parallel port, game port, or a universal serial bus (USB).

A monitor 742 or other type of display device can also be connected to the system bus 708 via an interface, such as a video adapter 744. In addition to the monitor 742, other output peripheral devices can include components such as speakers (not shown) and a printer 746 which can be connected to computer 702 via the input/output interfaces 740.

Computer 702 can operate in a networked environment using logical connections to one or more remote computers, such as a remote computing-based device 748. By way of example, the remote computing-based device 748 can be a personal computer, portable computer, a server, a router, a network computer, a peer device or other common network node, and the like. The remote computing-based device 748 is illustrated as a portable computer that can include many or all of the elements and features described herein relative to computer 702.

Logical connections between computer 702 and the remote computer 748 are depicted as a local area network (LAN) 750 and a general wide area network (WAN) 752. Such networking environments are commonplace in offices, enterprise-wide computer networks, intranets, and the Internet.

When implemented in a LAN networking environment, the computer 702 is connected to a local network 750 via a network interface or adapter 754. When implemented in a WAN networking environment, the computer 702 typically includes a modem 756 or other means for establishing communications over the wide network 752. The modem 756, which can be internal or external to computer 702, can be connected to the system bus 708 via the input/output interfaces 740 or other appropriate mechanisms. It is to be appreciated that the illustrated network connections are exemplary and that other means of establishing communication link(s) between the computers 702 and 748 can be employed.

In a networked environment, such as that illustrated with computing environment 700, program modules depicted relative to the computer 702, or portions thereof, may be stored in a remote memory storage device. By way of example, remote application programs 758 reside on a memory device of remote computer 748. For purposes of illustration, application programs and other executable program components such as the operating system are illustrated herein as discrete blocks, although it is recognized that such programs and components reside at various times in different storage components of the computing-based device 702, and are executed by the data processor(s) of the computer.

Various modules and techniques may be described herein in the general context of computer-executable instructions, such as program modules, executed by one or more computers or other devices. Generally, program modules include routines, programs, objects, components, data structures, etc. that performs particular tasks or implement particular abstract data types. Typically, the functionality of the program modules may be combined or distributed as desired in various embodiments.

An implementation of these modules and techniques may be stored on or transmitted across some form of computer readable media. Computer readable media can be any available media that can be accessed by a computer. By way of example, and not limitation, computer readable media may comprise “computer storage media” and “communications media.”

“Computer storage media” includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

Alternately, portions of the framework may be implemented in hardware or a combination of hardware, software, and/or firmware. For example, one or more application specific integrated circuits (ASICs) or programmable logic devices (PLDs) could be designed or programmed to implement one or more portions of the framework.

### CONCLUSION

Although embodiments for implementing a unified console for managing devices on a computer network have been described in language specific to structural features and/or methods, it is to be understood that the subject of the appended claims is not necessarily limited to the specific features or methods described. Rather, the specific features and methods are disclosed as exemplary implementations for providing a unified console for management of devices in a computer network.

What is claimed is:

1. A server computing device comprising:
a memory;
one or more processors operatively coupled to the memory; and
a workload module in the memory, wherein the workload module implements workload management of the server computing device and one or more client devices.

2. The server computing device of claim 1, wherein the workload module performs one or more of the following tasks: component updating, implementing policy, and generating reports.

3. The server computing device of claim 2, wherein data for affecting the tasks performed b the workload module is stored in a workload data in the memory.

4. The server computing device of claim 1, wherein the workload module allows information retrieval associated with various workloads.

5. The server computing device of claim 1, wherein the workload module generates and provides a user interface used for managing the workload management.

6. The server computing device of claim 5, wherein the workload module generates the user interface based on user interface data stored in memory.

7. The server of claim 1 further comprising a network interface to allow communication between the server device and the one or more client devices.

8. The server of claim 1 further comprising a reporting module that generates reports that include information associated processes.

9. In a computer system having a graphical user interface including a display and a user interface selection device, a method of system and workload management, comprising the steps of:
providing a single console for a managing server computing device and client computing devices;
connecting to workload components of the server computing device and client computing devices; and
managing a connection between the graphical user interface and workloads of the workload components.

10. The computer system of claim 8, wherein the providing includes one or more of the following in the graphical user interface: a navigation pane, a views pane, a wunderbar pane, a result pane, a detail pane, and an action pane.

11. The computer system of claim 10, wherein the views pane includes options to add client computing devices.

12. The computer system of claim 10, wherein the wunderbar pane include control elements used for performing functions associated with workload management.

13. The computer system of claim 10, wherein the result pane includes attributes associated with the computing devices.

14. The computer system of claim 10, wherein the action pane is split up into discrete groupings of actions.

15. A method for implementing workload management comprising:
detecting computing devices in a network;
detecting computing devices and groups of computing devices over which a workload is to be implemented;
configuring the workload across the computing devices and groups of computing device in which the workload is to be implemented; and
applying the configured workload over the computing devices and groups of computing device in which the workload is to be implemented.

16. The method of claim 15, wherein the groups are created based on characteristics common to the computing devices.

17. The method of claim 15, wherein a group policy aggregates one or more computing devices into a group.

18. The method of claim 15, wherein the configuring is performed by a user.

19. The method of claim 15, wherein the configuring is defined by a group policy.

20. The method of claim 15 further comprising maintaining an access control list of configured computing devices and groups.
